(19) United States
(12) Patent Application Publication
(10) Pub. No.: US 2026/0175479 A1
(43) Pub. Date: Jun. 25, 2026

(54) FOAMED ARTICLE

(71) Applicant: SABIC GLOBAL TECHNOLOGIES B.V., Bergen op Zoom (NL)

(72) Inventors: Kar-Man Raymond CHU, Maastricht (NL); Mark Leo Hendrik THEUNISSEN, Brunssum (NL); Emanuel Joseph Herman Marie VAN DER VEN, Waalre (NL); Martin Antonius VAN ES, Epen (NL)

(21) Appl. No.: 19/126,829

(22) PCT Filed: Nov. 3, 2023
(86) PCT No.: PCT/EP2023/080686

§ 371 Date: May 2, 2025

(30) Foreign Application Priority Data
Nov. 4, 2022 (EP) 22205600.4

(51) Int. Cl. B29C 45/00; C08L 23/16

(52) U.S. Cl. CPC B29C 45/0001; C08L 23/16; C08L 2205/025; C08L 2666/06

(57) ABSTRACT

An article including a foamed sheet prepared by foam injection molding of a polymer composition including a high melt strength polypropylene, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s2 of ≥30 cN.

### CROSS REFERENCE TO RELATED APPLICATIONS

This application is a National Stage Application of PCT/EP2023/080686, filed Nov. 3, 2023, which claims the benefit of European Application No. 22205600.4, filed Nov. 4, 2022, both of which are incorporated by reference in their entirety herein.

### BACKGROUND

The present invention relates to an article comprising a foamed sheet, in particular a panel for a building, a transportation or recreation vehicle or a shipping container.

For years, panels and planks of wood and its derivatives have been extensively used as structural elements in buildings and transportation. However, wood is susceptible to mold and mildew, and may require treatment to prevent bugs and pests. There is a need in the industry for structural panels that are recyclable and have good mold & pest resistant, flexural stiffness and compression strength, which can be made in a simple and sustainable manner.

Structural foam boards have been available in the market as alternatives to wood, mid-density fiberboard (MDF, 600-800 kg/m3), and low-density fiberboard (LDF, 300-500 kg/m3), offering better resistant to mold, mildew, and pest.

Examples of structural foam boards are extruded foam boards from PP, PET, PU and molded expanded PP (EPP) boards. The foam core may also be covered by faces sheets to become multilayer composites, providing improved aesthetics and other performance, e.g., scratch and abrasion. Examples of face-sheets are wood, MDF, plastics, and glass-fiber reinforced layers. An extra step is needed to bond the face-sheets to the foam core; which may include the use of glue, adhesives, and/or thermal lamination. Such step incur additional cost, complexity, and also reduce the recyclability of the composites (mixed materials).

WO2023118202A1 discloses a sheet having an improved compression stress at yield in the thickness direction. The sheet is produced by orienting and assembling a plurality of elongated foam elements produced from foam extrusion. Due to anisotropy elliptical cells, composite with improved compression performance in the thickness direction is obtained. A multilayer composite comprising such sheet and cover layers is also disclosed, which can be a panel for a building or a transportation or recreation vehicle.

EP4140723 discloses a multilayer composite comprising assembly of elongated foam element for shipping container.

WO2023143926A1 discloses a moulded polymer article used as cups or containers for liquid and/or food. The article comprises a monolithic wall part composed of a polymer, the monolithic wall part comprising a core layer of expanded cellular foam, composed of the polymer. The core layer is multilaminar and comprises a first layer of the expanded cellular foam adjacent to the first solid skin, a second layer of the expanded cellular foam adjacent to the second solid skin, and an intermediate layer of the expanded cellular foam which is between, and adjacent to, the first and second layers.

The expansion is performed at an expansion factor of 2 to 4.

### SUMMARY

It is an object of the present invention to provide an article, in particular a panel for a building, a transportation or recreation vehicle or a shipping container, which has a low density and a good compression performance.

Accordingly, the present invention provides an article, in particular a panel for a building, a transportation or recreation vehicle or a shipping container, comprising a foamed sheet prepared by foam injection molding of a polymer composition comprising a high melt strength polypropylene, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s² of ≥30 cN.

### DETAILED DESCRIPTION

It was surprisingly found that the high melt strength polypropylene in the polymer composition used for making the foamed sheet allows the foamed sheet according to the invention to have a low density and a good compression performance. It was found according to the invention that the high melt strength polypropylene allows foam injection molding at a relatively high expansion ratio for achieving low density without the cells to be ruptured, which results in a good compression performance.

The foamed sheet prepared by foam injection molding of a polymer composition comprising a high melt strength polypropylene has non-porous skin layers on its surface and a porous structure having foam cells oriented perpendicular to the thickness direction of the sheet. The oriented cells provide the foam to have improved compression strength in this critical load-bearing direction, making them viable alternatives to conventional structural panels, planks or flooring made from wood (timber), MDF, LDF and their composites. The non-porous skin layers provide flexural stiffness to the foamed sheet.

### Foam Injection Molding

Generally, to prepare a foamed article such as a foamed sheet, a polymer composition is mixed with a foaming agent. Then the mixture is heated to cause the polymer composition to melt and to cause the foaming agent to yield gas. Instead of first providing a mixture of a foaming agent and the polymer composition and subsequently melting the mixture to obtain a molten mixture, it is also possible to provide a melt of the polymer composition and mix a foaming agent into the melt of the polymer composition to obtain a molten mixture. Depending on the process, the resulting mixture is maintained as a gas laden melt until it is dispensed in a controlled manner through orifices or into shaping cavities. When the foaming is complete, the foamed article is allowed to solidify by cooling. Such processes are known in the art, e.g. from Thermoplastic Foams, by James L. Throne, Sherwood Publishers 1996, hereby incorporated by reference.

Preferably, the foam injection molding is performed by expanding a molten mixture having a thickness of t0 in a mold to the foamed sheet having a thickness of t1 at an expansion ratio t1/t0 of more than 4, preferably 4.1 to 20, more preferably 4.3 to 15, more preferably 4.5 to 12, more preferably 4.8 to 10.

Preferably, the foam injection molding comprises sequential steps of:
a) providing a mixture of a foaming agent and the polymer composition and melting the mixture to obtain a molten mixture or b) providing a melt of the polymer composition and mixing a foaming agent into the melt of the polymer composition to obtain a molten mixture;
injection molding the molten mixture into a mold;
optionally applying a pressure to the molten mixture in the mold;
opening the mold at least partially to allow the molten mixture to form a soft foamed article; and
allowing the soft foamed article to solidify to form the foamed sheet and eject the foamed sheet from the mold.

This process is sometimes referred as core-back injection molding process or a mold motion process. The density reduction achieved may be at least 75%, e.g. the density of the foamed sheet may be at most 345 kg/m³.

Preferably, the foamed sheet has a density of at most 340 kg/m³, at most 320 kg/m³, at most at most 300 kg/m³, at most 280 kg/m³, at most 260 kg/m³, at most 240 kg/m³, at most 226 kg/m³, at most 220 kg/m³, at most 200 kg/m³, at most 180 kg/m³ or at most 160 kg/m³, wherein the density is determined according to ISO 845 (2006). In some preferred embodiments, the foamed sheet has a density of 170 to 210 kg/m³, wherein the density is determined according to ISO 845 (2006).

The foamed sheet may have a thickness of 0.1 to 20 cm, 0.3 to 10 cm or 0.5 to 5.0 cm. For example, the thickness may be 0.1 to 3.0 cm, 3.0 to 10 cm or 10 to 20 cm.

In some embodiments, the article is an interior wall panel and the foamed sheet has a thickness of at least 0.3 cm, for example at least 0.6 cm.

In some embodiments, the article is a (caravan) floor panel and the foamed sheet has a thickness of 1.0 to 5.0 cm, for example 1.5 to 3.5 cm.

In some embodiments, the article is a panel which is a soft foam floor interlockable tile and the foamed sheet has a thickness of 0.5 to 1.5 cm, for example 0.8 to 1.2 cm, for example ⅜ inch (9.525 mm).

The foaming agent used according to the invention can either be a physical foaming agent or a chemical foaming agent, wherein the chemical foaming agent is a chemical that decomposes at specific temperature to liberate gas(es), wherein physical foaming agent are either volatile liquids or gas(es). Typical chemical foaming agent includes but is not limited to azodicarbonamide, sodium bicarbonate, 5-phenyl tetrazole and citrate derivatives.

A typical physical foaming agent includes but is not limited to fluids such as nitrogen, carbon dioxide, hydrocarbons (e.g. butane, pentane) in gaseous or supercritical state; and their mixtures.

The amount of the foaming agent used in the present invention can be varied depending on its nature and the foaming performance of the foaming agent. In some instances, the amount of the foaming agent varies in the range of 0.2-5.0 wt % based on the total weight of the polymer composition.

Preferably, the amount of the polymer composition with respect to the foamed sheet is at least 90 wt %, at least 95 wt %, at least 98 wt %, at least 99 wt % or 100 wt %.

Preferably, the foamed sheet according to the invention has a compression stress at 10% compression (σ10) in the thickness direction determined by ISO 844 (2014) of at least 0.8 Mpa, more preferably at least 1.0 MPa, more preferably at least 1.2 Mpa.

Preferably, the foamed sheet according to the invention has a compression stress at 20% compression (σ20) in the thickness direction determined by ISO 844 (2014) of at least 0.8 Mpa, more preferably at least 1.0 MPa, more preferably at least 1.2 Mpa, more preferably at least 1.6 MPa.

Preferably, the foamed sheet according to the invention has a compression stress at 25% compression (σ25) in the thickness direction determined by ISO 844 (2014) of at least 0.8 Mpa, more preferably at least 1.0 MPa, more preferably at least 1.2 Mpa, more preferably at least 1.7 MPa.

Preferably, the foamed sheet according to the invention has a compression modulus determined by ISO 844 (2014) of at least 10.0 Mpa, more preferably at least 15.0 MPa.

Preferably, the foamed sheet according to the invention has a flexural modulus determined by ISO 844 (2014) of at least 250 Mpa, more preferably at least 350 MPa, more preferably at least 400 MPa.

### Polymer Composition

The polymer composition comprises a high melt strength polypropylene (HMS-PP). A high melt strength polypropylene is branched and, thus, differs from a linear polypropylene in that the polypropylene backbone covers side chains whereas a non-branched polypropylene, i.e. a linear polypropylene, does not cover side chains. The side chains have significant impact on the rheology of the polypropylene. Accordingly linear polypropylenes and high melt strength polypropylenes can be clearly distinguished by their flow behaviour under stress.

Branching can be generally achieved by using specific catalysts, i.e. specific single-site catalysts, or by chemical modification. Concerning the preparation of a branched polypropylene obtained by the use of a specific catalyst reference is made to EP 1 892 264. With regard to a branched polypropylene obtained by chemical modification it is referred to EP 0 879 830 A1. In such a case the branched polypropylene is also called high melt strength polypropylene.

Suitable examples of commercially available products of the high melt strength polypropylene are commercially available from Borealis AG under the trade name Daploy™, for example Daploy™ WB140HMS.

Another suitable example of commercially available products of the high melt strength polypropylene is Achieve™ Advanced PP6302E1 from Exxon Mobil.

The high melt strength polypropylene used according to the invention has a melt strength of ≥30 cN. The melt strength of the high melt strength polypropylene is herein determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s².

High melt strength polypropylene having a melt strength 30 cN can for example be obtained by the process as disclosed in WO2009/003930A1. WO2009/003930A1 discloses an irradiated polymer composition comprising at least one polyolefin resin and at least one non-phenolic stabilizer, wherein the irradiated polymer composition is produced by a process comprising mixing the polyolefin resin with the non-phenolic stabilizer and irradiating this mixture in a reduced oxygen environment. In addition, a high melt strength polypropylene having a melt strength 45 cN is available from SABIC as SABIC® PP UMS 561 P as of 18 Feb. 2021.

Preferably, the high melt strength polypropylene is prepared by
a) irradiation of a polypropylene with at least one non-phenolic stabilizer, preferably wherein the non-phenolic stabilizer is chosen from the group of hindered amines, wherein the irradiation is performed with ≥2.0 and ≤20 Megarad electron-beam radiation in a reduced oxygen environment, wherein the amount of active oxygen is ≤15% by volume with respect to the total volume of the reduced oxygen environment for a time sufficient for obtaining a long chain branched polypropylene and
b) deactivation of the free radicals in the long chain branched polypropylene to form the high melt strength polypropylene.

How to deactivate the free radicals is known in the art, for example by heating as described in WO2009003930A1.

Examples of non-phenolic stabilizers are known in the art and are for example disclosed on pages 37-60 of WO2009/003930A1, hereby incorporated by reference. Preferably, the non-phenolic stabiizer is chosen from the group of hindered amines. More preferably, the non-phenolic stabilizer comprises at least one hindered amine selected from the group of Chimassorb® 944, Tinuvin® 622, Chimassorb® 2020, Chimassorb®119, Tinuvin® 770, and mixtures thereof, separate or in combination with at least one hydroxylamine, nitrone, amine oxide, or benzofuranone selected from N,N-di(hydrogenated tallow)amine (Irgastab® FS-042), an N,N-di(alkyl)hydroxylamine produced by a direct oxidation of N,N-di(hydrogenated tallow)amine (Irgastab® FS-042), N-octadecyl-α-heptadecylnitrone, Genox™ EP, a di(C16-C18)alkyl methyl amine oxide, 3-(3,4-dimethylphenyl)-5,7-di-tert-butyl-benzofuran-2-one, Irganox® HP-136 (BFI), and mixtures thereof, and separate or in combination with at least one organic phosphite or phosphonite selected from tris(2,4-di-tert-butylphenyl) phosphite (Irgafos® 168). Even more preferably, the non-phenolic stabilizers of the present subject matter can include those described in U.S. Pat. Nos. 6,664,317 and 6,872,764, both of which are incorporated herein by reference in their entirety.

Preferably, the melt strength of the high melt strength polypropylene is ≥35 cN, preferably ≥37 cN, preferably ≥40 cN, preferably ≥45 cN, more preferably ≥50 cN, more preferably ≥55 cN, even more preferably ≥60 cN, most preferably ≥65 cN and/or preferably the melt strength of the high melt strength polypropylene is ≤100 cN, for example ≤95 cN, for example ≤90 cN, for example ≤87 cN.

With polypropylene as used herein is meant propylene homopolymer, a copolymer of propylene with an α-olefin or a heterophasic propylene copolymer.

Preferably, the high melt strength polypropylene is polypropylene chosen from the group of propylene homopolymers and propylene copolymers comprising moieties derived from propylene and one or more comonomers chosen from the group of ethylene and alpha-olefins with ≥4 and ≤12 carbon atoms.

Preferably, the propylene copolymer comprises moieties derived from one or more comonomers chosen from the group of ethylene and alpha-olefins with ≥4 and ≤12 carbon atoms in an amount of ≤10 wt %, for example in an amount of ≥1.0 and ≤7.0 wt % based on the propylene copolymer, wherein the wt % is determined using ¹³C NMR. For example, the propylene copolymer comprises moieties derived from one or more comonomer chosen from the group of ethylene, 1-butene, 1-pentene, 1-hexene, 4-methyl-1-pentene, 1-heptene, 1-octene, 1-decene and 1-dodecene, preferably moieties derived from ethylene.

Polypropylenes and the processes for the synthesis of polypropylenes are known. A propylene homopolymer is obtained by polymerizing propylene under suitable polymerization conditions. A propylene copolymer is obtained by copolymerizing propylene and one or more other comonomers, for example ethylene, under suitable polymerization conditions. The preparation of propylene homopolymers and copolymers is for example described in Moore, E. P. (1996) Polypropylene Handbook.

Polymerization, Characterization, Properties, Processing, Applications, Hanser Publishers: New York.

Propylene homopolymers, propylene copolymers and heterophasic propylene copolymers can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Preferably, the high melt strength polypropylene has a melt flow rate ≥0.50 and ≤8.0 g/10 min, more preferably ≥0.70 and ≤5.0 g/10 min, most preferably ≥1.0 and ≤4.0 g/10 min as determined in accordance with ASTM D1238 (2013) at a temperature of 230° C. under a load of 2.16 kg.

Preferably, the high melt strength polypropylene has a VOC value as determined in accordance with VDA278 (2011-10) ≤250 μg/g, preferably a VOC value ≤50 μg/g and/or an FOG value as determined in accordance with VDA278 (2011-10) ≤500 μg/g, preferably an FOG-value ≤100 μg/g.

Preferably, the high melt strength polypropylene has a molecular weight distribution Mw/Mn of 5 to 20, preferably 7 to 17, most preferably 10 to 15. Mw and Mn may be measured by universal size exclusion chromatography (SEC), as described in ASTM D6474-12, using:
Chromatography: PolymerChar GPC-IR system running at 160° C.
Detection: Polymer Char IR5 infrared detector; PolymerChar viscometer
IR5 is used as concentration detector.
Column set: three Polymer Laboratories 13 μm PLgel Olexis, 300×7.5 mm
PE molar mass calibration was performed with linear PE standards (narrow and broad (Mw/Mn=4 to 15)) in the range of 0.5-2800 kg/mol
Concentration of samples injected are 0.03% m/m stabilized with Irgafos 168 and Topanol CA (weight ratio sample: Irgafos:Topanol=1:1:1)
Solvent and Eluent is 1,2,4-trichlorobenzene stabilized with 1 g/L BHT

Preferably, the amount of the high melt strength polypropylene with respect to the total polymer composition is at least 20 wt %, at least 30 wt %, at least 40 wt %, at least 50 wt %.

In some preferred embodiments, a large proportion of the polymer composition is the high melt strength polypropylene. For example, the amount of the high melt strength polypropylene with respect to the total polymer composition is at least 60 wt %, at least 70 wt %, at least 80 wt %, at least 90 wt %, at least 95 wt %, at least 98 wt %, at least 99 wt %, at least 99.5 wt %, at least 99.9 wt % or 100 wt %. This results in a particularly low density and a particularly good compression performance.

The polymer composition may comprise a further polypropylene which is not a high melt strength polypropylene. Said further polypropylene has a melt strength <30 cN. The melt strength of said further polypropylene may be <10 cN. The further polypropylene can be a propylene homopolymer, a propylene copolymer, for example a copolymer of propylene with an α-olefin as described herein or a heterophasic propylene copolymer. This allows obtaining combinations of desirable mechanical properties of the article according to the invention.

For example, the amount of said further polypropylene with respect to the total polymer composition is 5.0 to 80 wt %, for example 5.0 to 40 wt % or 40 to 80 wt %.

In some preferred embodiments, a large proportion of the polymer composition is the high melt strength polypropylene and the further polypropylene. For example, the total amount of the high melt strength polypropylene and the further polypropylene with respect to the total polymer composition is at least 60 wt % or at least 70 wt %, at least 80 wt %, at least 90 wt %, at least 95 wt %, at least 98 wt %, at least 99 wt %, at least 99.5 wt % or at least 99.9 wt % or 100 wt %. The polymer composition may be free of or substantially free of reinforcement inorganic fibers such as glass fibers, meaning the amount of reinforcement inorganic fibers is less than 0.1 wt % with respect to the polymer composition. This allows obtaining combinations of desirable mechanical properties without using reinforcement inorganic fibers such as glass fibers.

In some preferred embodiments, the polymer composition comprises glass fibers. Preferably, the amount of the glass fibers with respect to the total polymer composition is 0.1 to 40 wt %, 0.5 to 30 wt %, 1.0 to 25 wt %, 2.0 to 20 wt % or 5.0 to 15 wt %. This results in good flexural properties of the foamed sheet.

The glass fibers can have an average fiber length, before compounding, of 1-10 mm, preferably 2-8 mm, more preferably 3-7 mm. The diameter of the glass fibers, before compounding, can be 5-50 μm, preferably 8-30 μm, more preferably 10-20 μm.

In some preferred embodiments, a large proportion of the polymer composition is the high melt strength polypropylene and the glass fibers. For example, the total amount of the high melt strength polypropylene and the glass fibers with respect to the total polymer composition is at least 60 wt % or at least 70 wt %, at least 80 wt %, at least 90 wt %, at least 95 wt %, at least 98 wt %, at least 99 wt %, at least 99.5 wt % or at least 99.9 wt % or 100 wt %. This results in good flexural properties of the foamed sheet.

In some preferred embodiments, the polymer composition comprises the further polypropylene which is not a high melt strength polypropylene and the glass fibers. Preferably, the amount of the high melt strength polypropylene is 20 to 90 wt %, the amount of the further polypropylene is 5.0 to 40 wt %, the amount of the glass fibers is 0.1 to 40 wt %. This allows obtaining combinations of desirable mechanical properties.

Preferably, the total amount of the high melt strength polypropylene, the further polypropylene and the glass fibers with respect to the total polymer composition is at least 90 wt %, at least 95 wt %, at least 98 wt %, at least 99 wt %, at least 99.5 wt % or at least 99.9 wt % or 100 wt %.

The polymer composition may further comprise additives, such as for example flame retardants, pigments, lubricants, slip agents flow promoters, antistatic agents, processing stabilizers, long term stabilisers and/or UV stabilizers. The additives may be present in any desired amount to be determined by the man skilled in the art, but are preferably present ≥0.001 wt % and ≤5.0 wt %, more preferably ≥0.01 wt % and ≤4.0 wt %, even more preferably ≥0.01 wt % and ≤3.0 wt %, even more preferably ≥0.01 wt % and ≤2.0 wt % based on the polymer composition.

The polymer composition may further comprise a nucleating agent. A nucleating agent may be desired to increase the cell density and to modify the dynamics of bubble formation and growth. (Gendron, Thermoplastic foam Processing, 2005, page 209).

The amount of nucleating agent may for example be ≥0.010 wt % and ≤5.0 wt %, for example ≥0.030 wt % and ≤4.0 wt %, for example ≥0.050 wt % and ≤3.0 wt %, preferably ≥0.10 wt % and ≤2.5 wt %, more preferably ≥0.30 wt % and ≤1.5 wt % based on the polymer composition, most preferably ≥0.50 wt % and ≤1.2 wt % based on the polymer composition.

Suitable nucleating agents include but are not limited to talc, silica and a mixture of sodium bicarbonate and citric acid. Other suitable nucleating agents include amides, for example azo dicarbonamide, amines and/or esters of a saturated or unsaturated aliphatic (C₁₀-C₃₄) carboxylic acid. Examples of suitable amides include fatty acid (bis)amides such as for example stearamide, caproamide, caprylamide, undecylamide, lauramide, myristamide, palmitamide, behenamide and arachidamide, hydroxystearamides and alkylenediyl-bis-alkanamides, preferably (C₂-C₃₂) alkylenediyl-bis-(C₂-C₃₂) alkanamides, such as for example ethylene bistearamide (EBS), butylene bistearamide, hexamethylene bistearamide, ethylene bisbehenamide and mixtures thereof. Suitable amines include or instance (C₂-C₁₈) alkylene diamines such as for example ethylene biscaproamine and hexamethylene biscaproamine. Preferred esters of a saturated or unsaturated aliphatic (C₁₀-C₃₄) carboxylic acid are the esters of an aliphatic (C₁₆-C₂₄) carboxylic acid. Preferably, the nucleating agent is chosen from the group of talc, sodium bicarbonate, citric acid, azodicarbonamide and mixtures thereof, more preferably, the nucleating agent is talc.

For the preparation of the foamed sheet, it may be desired to use a cell stabilizer. Cell stabilizers are permeability modifiers which retard the diffusion of for example hydrocarbons such as isobutane to create dimensionally stable foams. (Gendron, Thermoplastic foam Processing, 2005, pages 31 and 149) Preferred cell stabilizers include but are not limited to glycerol monostearate (GMS), glycerol monopalmitate (GMP), palmitides and/or amides. Suitable amides are for example stearyl stearamide, palmitide and/or stearamide. Suitable mixtures include for example a mixture comprising GMS and GMP or a mixture comprising stearamide and palmitamide. Preferably, in case a cell stabilizer is used, the cell stabilizer is glycerol monostearate or stearamide.

The amount of cell stabilizer to be added depends on desired cell size and the polymer composition used for the preparation of the foamed sheet. Generally, the cell stabiliser may be added in an amount ≥0.10 and ≤3.0 wt % relative to the polymer composition.

Preferably, the foamed sheet has an open cell content of ≤15.0%, preferably ≤12.0%, more preferably ≤10.0%, even more preferably ≤7.0%, even more preferably ≤5.0%, even more preferably ≤4.0%, even more preferably ≤3.0%, even more preferably ≤2.0%, wherein the open cell content is determined according to ASTM D6226-10. Such foamed sheet has a combination of good heat insulation properties and mechanical properties.

Preferably, the polymer composition has a density of 0.885 to 1.365 g/cm³, for example 0.890 to 1.300 g/cm³, 0.900 to 1.200 g/cm³, 0.903 to 1.100 g/cm³, 0.904 to 1.000 g/cm³, 0.905 to 0.950 g/cm³.

### Multilayer Composite

The article according to the invention may be a multilayer composite comprising a core layer comprising the foamed sheet. The multilayer composite further comprises a first cover layer provided on the core layer. Preferably the multilayer composite further comprises a second cover layer on the opposite side of the core layer from the first cover layer. The core layer is thus provided between the first cover layer and the second cover layer. Preferred embodiments relate to a multilayer composite comprising a first cover layer, a second cover layer and a core layer provided between the first cover layer and the second cover layer, wherein the core layer comprises the sheet according to the invention. In some embodiments, the article according to the invention does not comprise such first cover layer and such second cover layer.

Preferably, the core layer is directly bonded to the first cover layer and the optional second cover layer without an adhesive layer. The direct bonding may be achieved by thermal bonding.

### First and Second Cover Layers

The first cover layer and/or the second cover layer may have a thickness of e.g. 0.1 to 4.0 mm, for example 0.3 to 2.0 mm.

The first cover layer comprises a first composition and the second cover layer comprises a second composition. The first composition and the second composition may be the same or different from each other.

Preferably, the first composition and/or the second composition is a non-foamed composition, more preferably the first composition is a non-foamed composition and the second composition is a non-foamed composition.

Preferably, the first composition and/or the second composition has a density of at least 0.903 g/cm³, more preferably at least 0.904 g/cm³, more preferably at least 0.905 g/cm³.

Preferably, the first composition and/or the second composition comprises polypropylene and optionally reinforcement fibers.

Preferably, the amount of polypropylene with respect to the total amount of polymers in the first composition is at least 90 wt %, at least 95 wt %, at least 98 wt %, at least 99 wt % or 100 wt %. Preferably, the amount of polypropylene with respect to the total amount of polymers in the second composition is at least 90 wt %, at least 95 wt %, at least 98 wt %, at least 99 wt % or 100 wt %.

In some embodiments, the reinforcement fibers may be glass fibers. In other embodiments, the reinforcement fibers may be selected from basalt fibers, carbon fibers, aramid fibers and natural fibers such as hemp, flax and bamboo fibers.

In some cases, the first composition and the second composition are free from reinforcement fibers. This is advantageous in view of recyclability.

### Glass Fibers

The glass fibers, as added to the first and/or second composition, can comprise long and/or short glass fibers.

Compositions filled with short glass fibers can be made by mixing chopped strands of pre-determined length with a thermoplastic polymer in an extruder, during which the glass fibers are dispersed in the molten thermoplastic. Compositions filled with long glass fibers can be made by a cable-wiring process, a co-mingling process or by a pultrusion process. The length of the added glass fibers can decrease during processing and as such the final length of the glass fibers in the composition and, in particular after compounding, can be less than that of the added glass fibers. Long glass fibers can have an average fiber length, before compounding, of 1 mm or more. Preferably, the long glass fibers can have an average fiber length, before compounding, of 1-50 mm, more preferably 1-20 mm, and even more preferably 5-15 mm. Short glass fibers can have an average fiber length, before compounding, of 1-10 mm, preferably 2-8 mm, more preferably 3-7 mm. The diameter of the glass fibers, before compounding, can be 5-50 μm, preferably 8-30 μm, more preferably 10-20 μm.

The aspect ratio of the fibers can for example be in the range of 200-2000, preferably in the range of 200-1000, such as in the range of 250-750. The aspect ratio refers to the ratio between the average fiber length and the average fiber diameter. Generally, the length of glass fibers in a polymer composition decreases during a melt processing step like injection moulding. The average length of the glass fibers in a moulded article made from the composition according to the invention, i.e. after compounding, is therefore typically significantly shorter. Typically, after compounding, the glass fibers have an average fiber length of 1 mm or less. Preferably, the average fiber length in a moulded article (after compounding) can be from 0.05-0.9 mm, more preferably 0.1-0.6 mm, even more preferably 0.1-0.4 mm. Since the average glass fiber diameter does not substantially change upon compounding, the average glass fiber diameter in a moulded article made from the composition according to the invention, i.e. after compounding, can be in the range of 5-50 μm, preferably 8-30 μm, such as 10-20 μm.

Suitably, the glass fibers can be coated in order to improve the interaction with the polypropylene. Such coated glass fibers are also known in the art as sized glass fibers. Such coatings typically include amino-silane or silane coatings. Amino-silane and silane coated glass fibers are commercially available. Some examples include ECS03-480H (from NEG), 03T480 (from NEG), HP3270 (from PPG Industries), HP3299 (from PPG Industries), ECS 305H (from CPIC), ECS 305K (from CPIC), DS2100-13P (from Binani 3B fiberglass), DS2200-10P (from Binani 3B fiberglass), DS2200-13P (from Binani 3B fiberglass), OwensCorning SE4805 SE4850, SE4849 Type 30.

The glass fibers may be treated with a coupling agent so as to improve the interaction between the glass fibers and the polypropylene. Such coupling agents facilitate adhesion of the polypropylene to the polar glass fiber surface. Suitable coupling agents include functional organo-silanes, transition metal coupling agents, amino-containing Werner coupling agents and mixtures thereof. Examples of functional organo-silane coupling agents include β-aminopropyldimethylethoxysilane, γ-aminopropyltriethoxysilane, γ-aminopropyltrimethoxysilane, β-aminoethyltriethoxysilane, N-β-aminoethylamino-propyltrimethoxysilane, γ-isocyanatopropyltriethoxysilane, vinyl-trimethoxysilane, vinyl-triethoxysilane, allyl-trimethoxysilane, mercaptopropyltrimethoxysilane, mercaptopropyltriethoxysilane, glycidoxypropyltriethoxysilane, glycidoxypropyltrimethoxysilane, 4.5-epoxycyclohexyl-ethyltrimethoxysilane, ureidopropyltrimethoxysilane, ureidopropyltriethoxysilane, chloropropyltrimethoxysilane, and chloropropyltriethoxysilane. Examples of transition metal coupling agents include chrome, titanium and zirconium coupling agents.

Examples of amino-containing Werner type coupling agents include complex compounds in which a trivalent nuclear atom such as chromium is coordinated with an organic acid having amino functionality. Such treated glass fibers are known in the art. The amount of glass fibers in the thermoplastic composition can vary depending on the specific application and needs. For example, the amount of glass fibers in the thermoplastic composition may be 10-40 wt %, for example 20-30 wt % or 20-25% based on the total composition.

The glass fiber can be prepared from continuous lengths of fibers by, for example, a sheathing or wire-coating process, by crosshead extrusion, or by a pultrusion technique. Using these technologies, fibers strands impregnated or coated with a polymer are formed. The fiber can then be cut into a desired length and can optionally be formed into pellets or granules. The fibers can be further processed, e.g., by injection moulding or extrusion processes, into a composition.

In some preferred embodiments, the first cover layer and/or the second cover layer may be or may comprise a continuous glass fiber reinforced tape, e.g. described in WO2021053180A1, hereby incorporated by reference.

Preferably, in case a continuous glass fiber reinforced tape is used, at least two (for example 2, 3, 4, 5, 6, 7, 8, 9 or 10) tape layers are applied in the first cover layer and/or the second cover layer. The stacking of the tape layers is preferably done such that the tapes are in a quasi isotropic lay-up (for example a +0 90° stacking).

Examples of glass fiber reinforced tapes include but are not limited to UDMAX™ tapes and Polystrand™ tapes as commercially available. Furthermore, such tapes are also disclosed in WO2016/142786A1, hereby incorporated by reference, WO2016/142781A1, hereby incorporated by reference, WO2016/142784A1, hereby incorporated by reference.

Thus, the continuous glass fiber reinforced tape may be a fiber-reinforced composite comprising:
a matrix material including polypropylene; and
a non-woven fibrous region comprising a plurality of continuous glass fibers dispersed in the matrix material;
wherein the width and the length of the non-woven fibrous region are substantially equal to the width and the length, respectively, of the fiber-reinforced composite;
wherein the non-woven fibrous region has a mean relative fiber area coverage (RFAC) (%) of from 65 to 90 and a coefficient of variance (COV) (%) of from 3 to 20; and
wherein each of the plurality of continuous fibers is substantially aligned with the length of the fiber-reinforced composite.

Another example of a continuous glass fiber reinforced tape is for example described in WO2019122317A1, hereby incorporated by reference and in WO2019122318A1, hereby incorporated by reference.

In some preferred embodiments, the first cover layer and/or the second cover layer may be or may comprise a monoaxially drawn polypropylene multilayer film or tape e.g. as described in WO0308190. The film or tape may be of the AB or ABA type, having a stretch ratio of more than 12, having an E-modulus of at least 10 GPa, substantially consisting of a central layer (B) of polypropylene, and one or two other layers (A) of polypropylene, the DSC melting point of the material of the said other layers (A) being lower than the DSC melting point of the material of the said central layer (B), wherein the central layer (B) is between 50 and 99 wt. % of the material and the other layers (A) between 1 and 50 wt. %. It is of advantage to use a monoaxially drawn polypropylene multilayer film or tape as it makes the use of fibers redundant, thereby improving the recyclability.

Typically, the thickness of the first cover layer and/or the second cover layer is smaller than the thickness of the foamed sheet according to the invention, for example the thickness of the first cover layer and/or the second cover layer is at most 90%, at most 70%, at most 50%, at most 30%, at most 10% or at most 5% of the thickness of the foamed sheet according to the invention.

### Core Layer

The core layer comprises the foamed sheet according to the invention. The foamed sheet according to the invention may be present in the core layer at an amount of 50 to 100 wt % of the core layer.

In some embodiments, the core layer consists of the foamed sheet according to the invention.

In other embodiments, the core layer comprises a part consisting of the foamed sheet according to the invention and further one or more parts consisting of a third composition having a higher density than that of the foamed sheet according to the invention. Such parts consisting of the third composition may be present e.g. at the peripheral part of the core layer and/or multiple such parts may be distributed over the core layer. In some embodiments, the core layer consist of a central part consisting of the foamed sheet according to the invention and a peripheral part at least partly surrounding the circumference of the central part, wherein the peripheral part consists of a third composition. In some embodiments, the peripheral part completely surrounds the circumference of the central part.

The parts consisting of the third composition may function as a reinforcement of the core layer, e.g. for ensuring the attachment of the core layer to the first and the second cover layers. This is particularly useful for a multilayer composite wherein the first cover layer, the second cover layer and the core layer are screwed together. By using a third composition having a higher density than that of the assembly according to the invention for the peripheral part of the core layer, a more secure attachment by screw can be achieved.

Preferably, the third composition comprises polypropylene and optionally glass fibers.

Preferably, the third composition is a non-foamed composition.

Preferably, the third composition has a density of at least 903 g/cm³, preferably at least 904 g/cm³, more preferably at least 905 g/cm³.

Suitable components for the third composition are those described for the first composition and the second composition. The third composition may be the same or different from the first composition and/or the second composition.

The multilayer composite may further comprise a surface layer provided over the first cover layer and/or the second cover layer. The surface layer may for example be a decorative layer and may comprise e.g. PVC, wood.

The present invention further provides a process for making the multilayer composite according to the present invention, comprising the steps of:
a) providing the foamed sheet according to the invention on the first cover layer, b) placing the second cover layer on the foamed sheet and
c) bonding the first cover layer, the foamed sheet and the second cover layer to each other e.g. by double belt press.

### Articles

The invention provides a panel for a building, a transportation or recreation vehicle or a shipping container, wherein the panel comprises the foamed sheet according to the invention. In another aspect, the invention relates to use of the foamed sheet according to the invention for the preparation of a panel for a building, a transportation or recreation vehicle or a shipping container. The panel may be selected from the group consisting of a floor panel, a wall panel, a roof panel, an insulation panel, for example an inner wall or front wall panel for a truck, a roof panel of a house, a floor panel for a caravan, a door panel of a car, a bumper panel of a car. The panel may have a straight surface or a curved surface.

The invention further provides a process for preparing an article comprising a foamed sheet comprising foam injection molding of a polymer composition comprising a high melt strength polypropylene, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s² of ≥30 cN.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### Examples 1 and 2

Compositions as shown in Table 1 were loaded in an injection molding machine that has a 50 mm-diameter screw and a 150-ton clamping unit. The machine is also equipped with Trexel MuCell T-100 system for dosing 1.5 wt % carbon dioxide blowing agent for foam injection molding. The mold tool used comprises a fixed half and a moveable half. When the two halves are closed, the tool has a mold cavity of 90 mm-wide×160 mm-long rectangular plaque geometry. The cylinder and mold temperature used were 190° C. and 85° C., respectively. Gas-laden composition was first injected to fill the closed mold cavity. In the subsequent step, the movable half of the mold tool retrieves partially to an intermediate position, enabling the gas-laden material in the cavity to foam and expand from the initial (cavity) thickness, t0 of 3 mm, to the final foam thickness, t1 of 15 mm, having an expansion ratio of 5. The foam (sheet) was further cooled in the mold to solidify, and later, ejected from the mold.

Test specimens of rectangular prisms were machined from the foamed sheets. The machined specimens comprise foam core covered by skin layers on the top and bottom sides. The morphology and skin layer thickness of the specimens were examined with the use of microscope manufactured by Zeiss. Density of the specimens with and without the two skin layers was measured and is shown in Table 1. Compression stress at 10%, 20% and 25% compression (σ10, σ20, and σ25) in the thickness direction were determined by ISO 844 (2014) and are shown in Table 1. Compressive modulus and flexural modulus were also determined by ISO 844 (2014) and ISO 1209, respectively, and are shown in Table 1.

### Comparative Examples 1 and 2

Composition as shown in Table 1 was subjected to foam extrusion to obtain a foam of similar density to Example 1. Density of the sheet was measured and is shown in Table 1. The foam extrusion is processed in a 30 mm, 40 length over diameter ratio (L/D), co-rotating twin-screw foam extruder. The extruder consists of nine electrical heating zones equipped with water cooling, followed by a cooling section, a static mixer, and a slit die. PP-UMS 561 P and the nucleating agent masterbatch are heated and homogenized above 230° C. in the extruder. At a latter zone of the extruder, the physical blowing agent, isobutane, is metered and mixed with the molten polymer. The mixture is cooled to the foaming temperature of 170° C. and extruded through the slit die at throughput of 20 kg/hr for CEx 1 and 15 kg/hr for CEx2. The foamed sheet was obtained after cooling by a water-cooled calibrator unit. The extruded PP foam sheet is cut into rectangular prisms of 12 mm for CEx 1 and 20 mm for CEx 2 thickness for property measurement. Compression stress at 10%, 20%, and 25% compression in the thickness direction were determined by ISO 844 (2014) and are shown in Table 1.

TABLE 1

| | Ex 1 | | Ex 2 | | CEx 1 | | CEx 2 | |
|---|---|---|---|---|---|---|---|---|
| PP-UMS 561P | 97.5 | wt % | 30.0 | wt % | 99.5 | wt % | 97.0 | wt % |

| | | |
|---|---|---|
| PPc G3220A (20% SGF) | 70.0 | wt % |

| | | | | |
|---|---|---|---|---|
| Nucleating agent (talc) | 0.5 | wt % | 3.0 | wt % |

| Nucleating agent (CF40E) | 0.5 | wt % | | |
|---|---|---|---|---|
| Colorant (black) | 2.0 | wt % | | |
| Blowing agent (CO2) | 1.5 | wt % | 1.5 | wt % |

| | | | | |
|---|---|---|---|---|
| Blowing agent (isobutane) | 2.4 | wt % | 2.6 | wt % |

| Unfoamed material density [kg/m3] | 905 | 1000 | 905 | 905 |
|---|---|---|---|---|
| Overall foamed sheet density | 180 | 200 | 100 | 96 |
| [kg/m3] | | | | |
| Foam core density [kg/m3] | 101 | 111 | 100 | 96 |
| Skin layer [mm) | 0.8 | 0.8 | N/A | N/A |
| Overall thickness [mm] | 15 | 15 | 12 | 20 |
| σ10 [MPa] | 1.5 | 1.0 | 0.4 | 0.2 |
| σ20 [MPa] | 1.7 | 1.0 | 0.5 | 0.3 |
| σ25 [MPa] | 1.8 | 1.0 | 0.6 | 0.3 |
| Compressive Modulus [MPa] | 19.6 | 13.5 | N/A | N/A |
| Flexural Modulus [MPa] | 307.4 | 465.2 | N/A | N/A |

PP-UMS 561P is polypropylene having a melt strength of more than 65 cN.
SABIC ® PPcompound G3220A is a 20% short glass fiber reinforced Polypropylene.
The base material is a PP homopolymer.
The glass fibres are chemically coupled to the PP matrix.
Nucleating agent (talc): stands for POLYBATCH ® FPE 50 T, which is a 50% masterbatch of talcum based nucleating agent, which is commercially available from LyondellBasell.
Nucleating agent (CF40E): stands for HYDROCEROL ™ CF 40 E, which is a 40% masterbatch of sodium bicarbonate and citric acid derivatives based foam nucleating agent, which is commercially available from Avient Colorant (black): stands for PF48/92F, a black color masterbatch commercially available from Colloids Ltd.

Table 1 shows that the foamed sheet according to the invention prepared by foam injection molding of a polymer composition comprising a high melt strength polypropylene has a combination of low density and good compression performance.

1. An article comprising a foamed sheet prepared by foam injection molding of a polymer composition comprising a high melt strength polypropylene, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s² of ≥30 cN.

2. The article according to claim 1, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s² of ≥35 cN and/or the melt strength of the high melt strength polypropylene is ≤100 cN.

3. The article according to claim 1, wherein the high melt strength polypropylene has a molecular weight distribution Mw/Mn of 5 to 20, measured by universal size exclusion chromatography as described in ASTM D6474-12.

4. The article according to claim 1, wherein the amount of the high melt strength polypropylene with respect to the total polymer composition is at least 20 wt %.

5. The article according to claim 1, wherein the amount of the high melt strength polypropylene with respect to the total polymer composition is at least 60 wt %.

6. The article according to claim 1, wherein the polymer composition comprises a further polypropylene which is not a high melt strength polypropylene.

7. The article according to claim 6, wherein the total amount of the high melt strength polypropylene and the further polypropylene with respect to the total polymer composition is at least 60 wt %.

8. The article according to claim 1, wherein the polymer composition further comprises glass fibers.

9. The article according to claim 8, wherein the total amount of the high melt strength polypropylene and the glass fibers with respect to the total polymer composition is at least 60 wt %.

10. The article according to claim 1, wherein the polymer composition comprises a further polypropylene which is not a high melt strength polypropylene and glass fibers.

11. The article according to claim 1, wherein the foamed sheet has a density of at most 345 kg/m³, wherein the density is determined according to ISO 845 (2006).

12. The article according to claim 1, wherein the foam injection molding is performed by expanding a molten mixture having a thickness of t0 in a mold to the foamed sheet having a thickness of t1 at an expansion ratio t1/t0 of more than 4.

13. The article according to claim 1, wherein the article is a multilayer composite comprising a core layer comprising the foamed sheet, a first cover layer provided on the core layer.

14. The article according to claim 1, wherein the foam injection molding comprises sequential steps of:
a) providing a mixture of a foaming agent and the polymer composition and melting the mixture to obtain a molten mixture or b) providing a melt of the polymer composition and mixing a foaming agent into the melt of the polymer composition to obtain a molten mixture;
injection molding the molten mixture into a mold;
optionally applying a pressure to the molten mixture in the mold;
opening the mold at least partially to allow the molten mixture to form a soft foamed article; and
allowing the soft foamed article to solidify to form the foamed sheet and eject the foamed sheet from the mold.

15. The article according to claim 1, wherein the article is a panel for a building, a transportation or recreation vehicle or a shipping container.
